(19) United States
(12) Patent Application Publication
(10) Pub. No.: US 2009/0007759 A1
(43) Pub. Date: Jan. 8, 2009

(54) TWIRLING PROP AND METHOD OF PREPARING THE SAME

(76) Inventors: John Pearison, Poseyville, IN (US); Julie Mitchell, Evansville, IN (US); Kenny Fisher, Villemoiron-en-Othe (FR)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/773,153

(22) Filed: Jul. 3, 2007

(51) Int. Cl. G10G 7/00; A63H 1/00

(52) U.S. Cl. 84/477 B; 446/236

(57) ABSTRACT

A twirling prop devoid of a gun barrel and for use by a marching band or the like is provided. The twirling prop includes a body having a top surface, a bottom surface, a base, a distal end, and a midline. The top surface, bottom surface, and base are non-colinear and are constructed such that at least a portion of each can be gripped. Openings extending laterally through the body of the twirling prop can be present and can, in certain instances, provide a means for gripping the twirling prop. Such openings can be positioned anywhere along the length of the body between the top surface and the bottom surface and can be of any size and shape desired.

### FIELD OF THE INVENTION

The present invention relates to twirling props, such as those used by members of a marching band, as well as methods of preparing and using the same.

### BACKGROUND

There are a variety of show props commercially available. Many of these non-instrumental props are designed for use by members of a marching band (e.g., the color guard), and can include props such as flags, rifles, sabres, batons and the like. Although many of these props are useful and commercially successful, they are not ideal for certain applications. For example, it is generally desirable to provide a prop that is light weight, easily maneuverable and aesthically pleasing. However, certain characteristics of a prop can be undesirable in certain environments, such as those props shaped as weapons (e.g., rifles), particularly when such a prop is to be used by a marching band affiliated with a non-military school, college or university. Methods of preparing and using such props are also needed. Certain embodiments described herein address these and other needs.

### SUMMARY

In one aspect, a twirling prop is provided. The twirling prop includes a body having a top surface, a bottom surface, a base, a distal end and a midline. The top and bottom surfaces extend longitudinally between the base and the distal end of the body. The top surface, bottom surface and base of the body are non-colinear and are constructed such that at least a portion of each can be gripped. The twirling prop is also devoid of a gun barrel.

In another aspect, an alternate design for a twirling prop is provided. The twirling prop includes a body having a top surface, a bottom surface, a base, a distal end and a midline. The top and bottom surfaces extend longitudinally between the base and the distal end of the body. At least one opening is included in the body extending laterally therethrough between the top surface and the bottom surface at a location between the midline and the base of the body. The body also includes at least one opening extending laterally therethrough between the top surface and the bottom surface at a location between the midline and the distal end of the body. The top surface, bottom surface and base of the body are non-colinear.

The invention is set forth by the claims, and it is not limited by the foregoing. Additional embodiments as well as features and advantages of the invention will be apparent from the further descriptions herein.

### DESCRIPTION OF THE DRAWINGS

FIG. 1 is a perspective view of a twirling prop including a body having a top surface, a bottom surface, a base, a distal end, and a midline. The twirling prop is devoid of an opening.

FIG. 1B is a top plan view of the twirling prop of FIG. 1.

FIG. 1C is a bottom plan view of the twirling prop of FIG. 1.

FIG. 2 is a perspective view of the twirling prop depicted in FIG. 1, wherein the body includes three openings extending laterally therethrough between the top surface and the bottom surface.

FIG. 3 is a perspective view of the twirling prop depicted in FIG. 1, wherein the body includes four openings extending laterally therethrough between the top surface and the bottom surface.

FIG. 4 is a perspective view of an alternate twirling prop including a body having a top surface, a bottom surface, a base, a distal end and a midline. The body includes four openings extending laterally therethrough between the top surface and the bottom surface.

FIG. 4B is a top plan view of the twirling prop of FIG. 4.

FIG. 4C is a bottom plan view of the twirling prop of FIG. 4.

FIG. 5 is a perspective view of the twirling prop depicted in FIG. 4, wherein the top surface has a generally straight configuration.

FIG. 5B is a top plan view of the twirling prop of FIG. 5.

FIG. 5C is a bottom plan view of the twirling prop of FIG. 5.

FIG. 6 is a perspective view of another twirling prop including a body having a top surface, a bottom surface, a base, a distal end, and a midline. The body includes four openings extending laterally therethrough between the top surface and the bottom surface.

FIG. 6B is a top plan view of the twirling prop of FIG. 6.

FIG. 6C is a bottom plan view of the twirling prop of FIG. 6.

FIG. 7 is a perspective view of an alternate twirling prop including a body having a top surface, a bottom surface, a base, a distal end, and a midline, wherein the base and the distal end are of about the same height.

FIG. 7B is a top plan view of the twirling prop of FIG. 7.

FIG. 7C is a bottom plan view of the twirling prop of FIG. 7.

FIG. 8 is a perspective view of an alternate twirling prop including a body having a top surface, a bottom surface, a base, a distal end, and a midline. The twirling prop is devoid of an opening.

FIG. 8B is a top plan view of the twirling prop of FIG. 8.

FIG. 8C is a bottom plan view of the twirling prop of FIG. 8.

### BRIEF DESCRIPTION OF PREFERRED EMBODIMENTS

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Twirling props as described herein are typically devoid of a gun barrel, including both functional and non-functional gun barrels. A non-functional gun barrel refers to a hollow or a solid elongated piece that is positioned on a gun-like device where a gun barrel is known to be located. A gun-like device can be a previously functional firearm, such as a rifle, or can be a non-functional firearm, such as a rile prop used by marching bands. Such twirling props find particular use in environments where objects depicted like a firearm are undesirable. However, a gun barrel may be optionally present, such as in the claims not reciting “devoid of a gun barrel.”

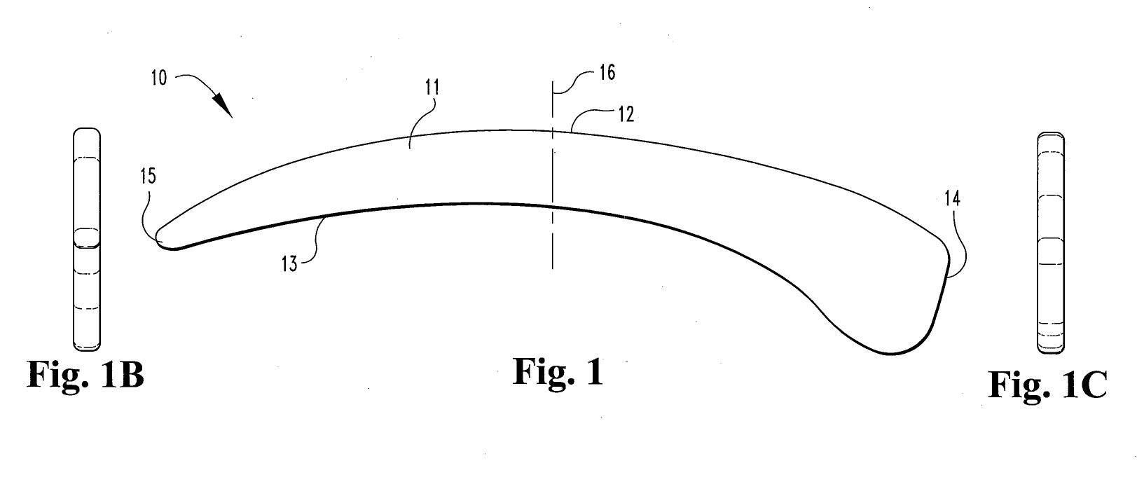

With reference now to FIG. 1, shown is one embodiment for a twirling prop. The twirling prop 10 includes a body 11 having a top surface 12, a bottom surface 13, a base 14, a distal end 15, and a midline 16. More specifically, top surface 12 and bottom surface 13 of body 11 extend longitudinally between base 14 and distal end 15 of body 11. Top surface 12, bottom surface 13 and base 14 are non-colinear; however, top surface 12 and bottom surface 13 can converge at base 14 and/or distal end 15. Preferably, top surface 12 and bottom surface 13 converge at distal end 15, as shown in FIG. 1.

As described above, the body of a twirling prop includes a top surface, a bottom surface, a base, a distal end, and a midline. Of these portions, the top surface, the bottom surface, and the base are constructed such that at least a portion of each can be gripped, for example, by a member of a marching band. In one embodiment, the top surface of the body can be constructed such that it can be gripped at a location between the midline and the base of the body. Alternatively or additionally, the bottom surface of the body can be constructed such that it can be gripped at a location between the midline and the distal end of the body.

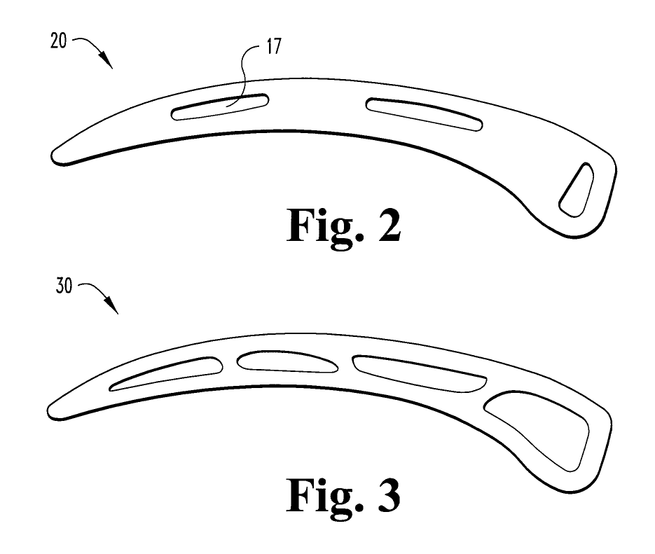

In preferred embodiments, the body of a twirling prop, such as body 11, can include at least one opening extending along its length. The at least one opening can, in certain instances, serve as the means for gripping the body at the top surface, the bottom surface and/or the base of the body. In this respect, the body of the twirling prop can include at least one opening extending laterally therethrough between the top surface and the bottom surface. Preferably, the body includes at least a second opening, or even at lest a third, extending laterally therethrough between the top surface and the bottom surface, such as exhibited in openings 17 of twirling prop 20 depicted in FIG. 2. In one preferred embodiment, the body includes at least four openings extending laterally therethrough between the top surface and the bottom surface, such as exhibited in twirling prop 30 depicted in FIG. 3. It will be understood that any number of openings can be provided in a twirling prop at any position along the length of the body so long as the twirling prop can be gripped at the top surface, the bottom surface and the base of the body.

The at least one opening can be of any suitable size and shape. Typically, the at least one opening will be of a sufficient size such that it can provide a means for gripping the body at the top surface, the bottom surface, and/or the base when positioned at any of these locations on the body of the twirling prop. In preferred embodiments, the opening can extend along the length of the body at least about 0.1 meter to at least about 0.3 meter. More preferably, the at least one opening can extend along the length of the body at least about 0.18 meter to at least about 0.23 meter. When more than one opening is included in the twirling prop, the length of these openings can be the same size or can be of different sizes. When different sized openings are contemplated for a twirling prop, it is preferred that these openings are within a length of about 0.05 meters of each other. Typically, the length of the at least one opening can correspond to the overall length of the twirling prop. Accordingly, the length of any opening included in the body of a twirling prop can increase as the overall length of the twirling prop increases. Along these lines, it is preferred to keep the distance from the outer walls of an opening to each of the top surface and bottom surface about the same regardless of the overall length of the body of the twirling prop. Moreover, if more than one opening is provided in the twirling prop, any number of these openings can overlap with any other opening provided in the prop, if desired.

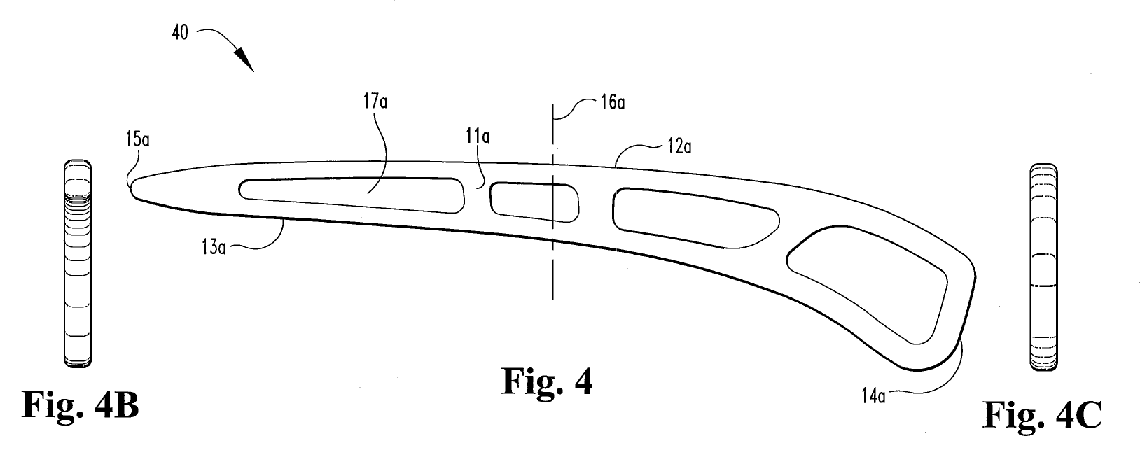

The opening(s), such as opening 17, can be provided along the length of the body at any location. For example, the body can include at least one opening at a location between the midline and the base of the body. Alternatively or additionally, the body can include at least one opening at a location between the midline and distal end of the body and/or at least one opening extending across the midline of the body. In one particularly preferred embodiment illustrated by twirling prop 40 depicted in FIG. 4, body 11a includes at least two openings 17a extending laterally therethrough at a location between midline 16a and base 14a of body 11a, at least one opening 17a at a location between midline 16a and distal end 15a of body 11a, and at least one opening 17a at a location extending across midline 16a of the body 11a.

In another embodiment, the body of a twirling prop as described herein can include at least a portion including truss structure. For example, twirling prop 40 includes a body whereby at least a portion of the body includes a truss structure.

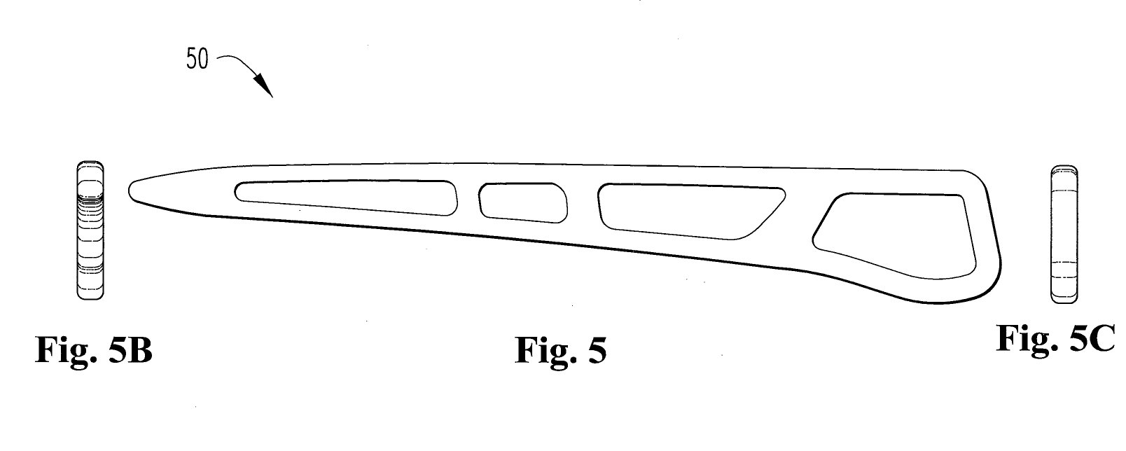

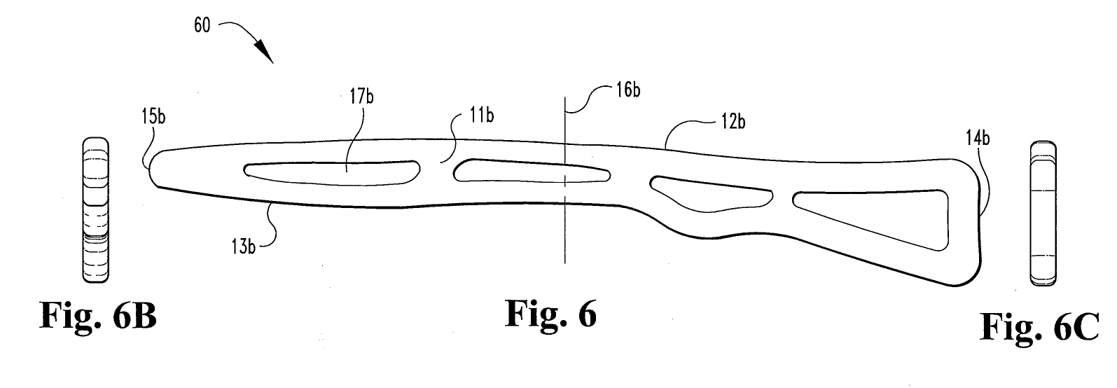

In certain embodiments, the body of the twirling prop can have a curvature. More specifically, the top surface and/or the bottom surface of the body can be along a continuous curve extending between the base and the distal end of the body. For example, FIGS. 1-3 each show both a top surface and a bottom surface along a continuous curve between the base and the distal end of the body. In certain other embodiments, the body of the twirling prop can be generally straight or can be curved, although not necessarily continuously along the length of the body. For example, FIG. 4 shows twirling prop 40 including a top surface 12a and a bottom surface 13a each having a degree of curvature, but this degree of curvature is not continuous along the entire length of body 11a. Similarly, twirling prop 60 as depicted in FIG. 6 includes a body 11b having a top surface 12b, a bottom surface 13b, a base 14b, a distal end 15b, and a midline 16b. Each of top surface 12b and bottom surface 13b includes curved portions; however, these curved portions are not continuous along the length of body 11b. FIG. 5 provides a twirling prop 50 where the top surface has a generally straight configuration, and the bottom surface has a degree of curvature that is not continuous along the entire length of the body. It will be understood that either or both of the top and bottom surfaces can have a straight or a curved configuration (i.e., continuous or non-continuous) so long as the top surface, bottom surface and base can be gripped.

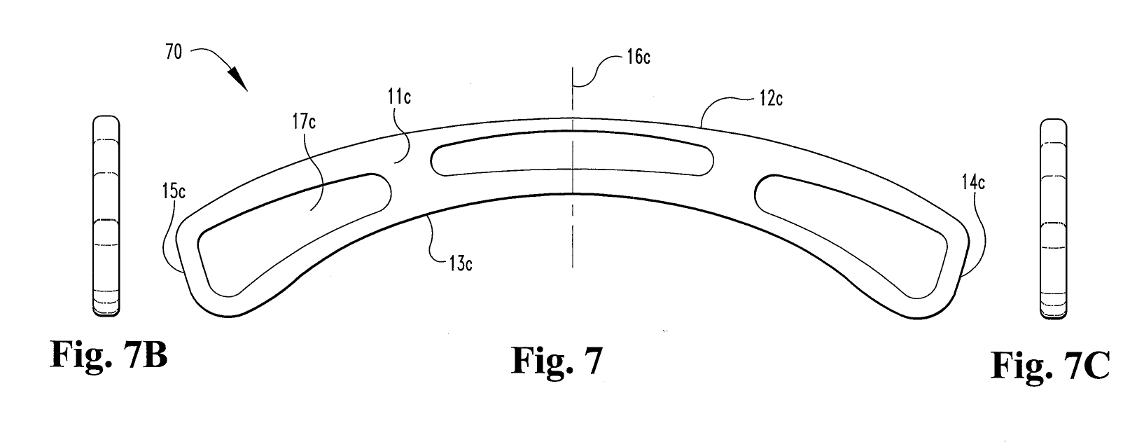

Turning now to FIG. 7, shown is an alternate twirling prop 70 including a body 11c having a top surface 12c, a bottom surface 13c, a base 14c, a distal end 15c, and a midline 16c. Body 11c is constructed such that base 14c and distal end 15c have about the same height. Each of top surface 12c and bottom surface 13c is on a continuous curve extending longitudinally between base 14c and distal end 15c. Body 11c of twirling prop 70 also includes one opening 17c extending from midline 16c to base 14c, one opening extending from midline 16c to distal end 15c, and one opening extending across midline 16c.

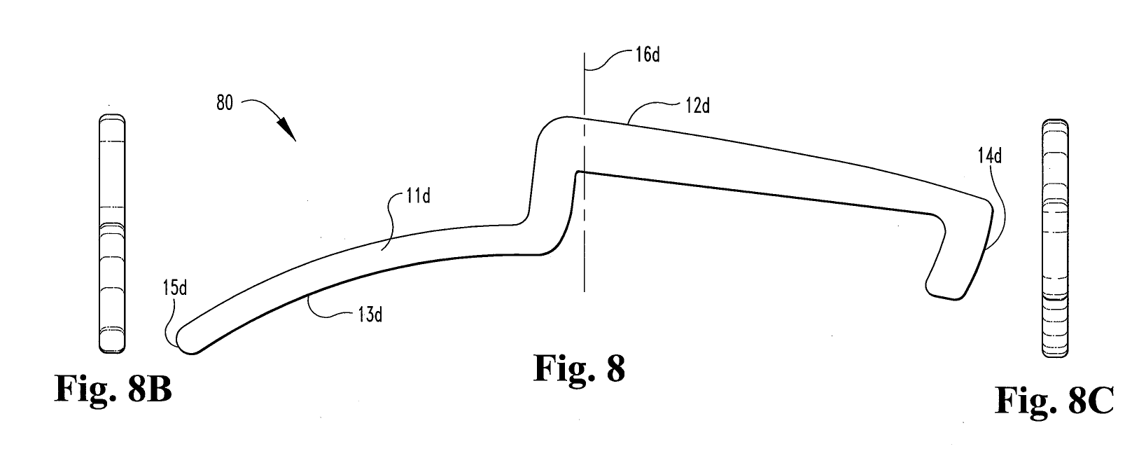

With reference now to FIG. 8, shown is another alternate twirling prop. Twirling prop 80 includes a body 11d having a top surface 12d, a bottom surface 13d, a base 14d, a distal end 15d, and a midline 16d. Body 11d of twirling prop 80 is devoid of any openings, and top surface 12d and bottom surface 13d are curved but are not on a continuous curve extending from base 14d to distal end 15d.

A twirling prop as described herein, including the twirling props depicted in FIGS. 1-8, can be made of any suitable material. Suitable materials include, for example, a rigid foam or wood material. Other materials will be generally known to those skilled in the art. Preferably, the material used will be such that the twirling prop has a weight less than about 1.5 kilograms. Preferably, the twirling prop has a weight ranging from about 0.5 to about 1.25 kilograms, and more preferably, ranging from about 0.75 to about 1.15 kilograms. In embodiments where wood is used to prepare the twirling prop, it is preferred that the wood is of the family Magnoliaceae. Within the Magnoliacea family, it is preferred that the wood used is of the genus Liriodendron, with the species Liriodendron tulipifera being most preferred. Typically, the wood is laminated prior to or after formation of the twirling prop. Means for lamination of a wood material are well known to those of ordinary skill in the art. In embodiments where foam is used to prepare the twirling prop, it is preferred that the foam material comprise a density of at least about 0.5 g/cm³. Closed cell, rigid foams generally have such a density. Preferably, the foam material comprises polyurethane, polyethylene, poly vinyl chloride, or ethylene vinyl acetate, with a polyurethane fiber foam being most preferred.

A twirling prop as described herein can be constructed so as to include a body having a length of between about 0.75 and about 2 meters extending from the base to the distal end. Preferably, the twirling prop includes a body having a length of between about 0.85 and about 1.25 meters, and more preferably has a length of between about 0.9 and about 1 meter. The base of the body will typically have a height ranging from about 0.1; to about 0.25 meter extending from the bottom surface to the top surface of the body. Additionally, the body will typically have a width ranging from about 0.01 to about 0.05 meter. In one particularly preferred embodiment, the twirling prop can have a weight ranging from about 0.9 to about 1.13 kilograms, a body having a length between about 0.9 and about 1 meter, a width ranging from about 0.03 and 0.04 meter, and a base having a height between about 0.15 and 0.2 meters.

To form a twirling prop as described herein, a suitable source material (e.g. foam or wood) is provided prior to being formed into its desired shape. The method for preparing a twirling prop will, at least in part, depend on the source material chosen. For twirling props constructed of a wood material, the wood is cut to its desired shape and sanded down to form a generally smooth surface. When a rigid foam material is used, such a twirling prop is typically formed by an injection molding process, which is generally known in the art. Briefly, a hot flow injection mold system including one or more molds in the shape of a twirling prop is employed and used in conjunction with a foam material, preferably a polyurethane fiber foam. Once the foam material is provided into the injection mold system, the mold system is activated by heat and chemical reaction to form and set the foam; thus forming a rigid foam material in the shape of one or more twirling props. Once formed, a twirling prop prepared from wood or foam can be decorated as desired, such as by application of paint or the like.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A twirling prop for use by a marching band or the like, comprising:
a body having a top surface, a bottom surface, a base, a distal end, and a midline;
said top and bottom surfaces extending longitudinally between said base and said distal end of said body;
wherein said top surface, said bottom surface and said base are non-colinear and are constructed such that at least a portion of each can be gripped; and
wherein said twirling prop is devoid of a gun barrel.

2. The twirling prop of claim 1, wherein said body further comprises at least one opening extending laterally therethrough between said top surface and said bottom surface.

3. The twirling prop of claim 2, wherein said body further comprises at least a second opening extending laterally therethrough between said top surface and said bottom surface.

4. The twirling prop of claim 3, wherein said body comprises at least one opening at a location between said midline and said base of said body.

5. The twirling prop of claim 2, wherein said body comprises at least one opening at a location between said midline and said distal end of said body.

6. The twirling prop of claim 1, wherein said top surface is constructed such that it can be gripped at a location between said midline and said base of said body.

7. The twirling prop of claim 1, wherein said bottom surface is constructed such that it can be gripped at a location between said midline and said distal end of said body.

8. The twirling prop of claim 1, wherein top surface is along a continuous curve extending between said base and said distal end of said body.

9. The twirling prop of claim 3, wherein said body includes at least a portion comprising a truss structure.

10. The twirling prop of claim 1, wherein said twirling prop has a weight less than about 1.5 kilograms.

11. The twirling prop of claim 1, wherein said twirling prop is constructed of a rigid foam material.

12. The twirling prop of claim 1, wherein said base has a height ranging from about 0.1 to about 0.25 meters extending between said bottom surface and said top surface of said body.

13. The twirling prop of claim 1, wherein said body has a length of between about 0.75 and about 2 meters extending between said base and said distal end.

14. The twirling prop of claim 1, wherein said body has a width ranging from about 0.01 to about 0.05 meters.

15. A twirling prop for use by a marching band or the like, comprising:
a body having a top surface, a bottom surface, a base, a distal end and a midline;
said top and bottom surfaces extending longitudinally between said base and said distal end of said body;
said body comprising at least one opening extending laterally therethrough between said top surface and said bottom surface at a location between said midline and said base of said body;
said body comprising at least one opening extending laterally therethrough between said top surface and said bottom surface at a location between said midline and said distal end of said body;
wherein said top surface, said bottom surface and said base are non-colinear and are constructed such that at least a portion thereof can be gripped; and
wherein said top surface is along a continuous curve extending between said base and said distal end of said body.

16. The twirling prop of claim 15, wherein said body further comprises at least a third opening extending laterally therethrough between said top surface and said bottom surface at a location between said midline and said base of said body.

17. The twirling prop of claim 15, wherein said body further comprises at least a fourth opening extending laterally therethrough and longitudinally across said midline of said body.

18. The twirling prop of claim 15, wherein said body further comprises at least a third opening extending laterally therethrough between said top surface and said bottom surface at a location between said midline and said base of said body; and wherein said body further comprises at least a fourth opening extending laterally therethrough and longitudinally between said top surface and said midline of said body.

19. The twirling prop of claim 15, wherein said top surface is constructed such that it can be gripped at a location between said midline and said base of said body.

20. The twirling prop of claim 15, wherein said bottom surface being constructed such that it can be gripped at a location between said midline and said distal end of said body.

21. The twirling prop of claim 15, wherein said top surface is constructed such that it can be gripped at a location between said midline and said base of said body; and wherein said bottom surface is constructed such that it can be gripped at a location between said midline and said distal end of said body.

22. The twirling prop of claim 15, wherein said twirling prop is devoid of a gun barrel.

23. The twirling prop of claim 15, wherein said bottom surface is along a continuous curve extending between said base and said distal end of said body.

24. The twirling prop of claim 15, wherein said top surface converges with said bottom surface at said distal end of said body.
